(19) United States
(12) Patent Application Publication
(10) Pub. No.: US 2008/0048422 A1
(43) Pub. Date: Feb. 28, 2008

(54) Safety Device for a Motor Vehicle Having a Front-End Structure

(75) Inventors: Guenter Eichhorn, Althengstett (DE); Mario Gassmann, Stuttgart (DE); Christian Gruber, Nessenfels (DE); Rudolf Mayer, Leonberg (DE); Harald Muehleisen, Leinfelden-Echterdingen (DE); Andreas Richter, Remseck (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 11/578,129

(22) PCT Filed: Mar. 30, 2005
(86) PCT No.: PCT/EP05/03300

§ 371 Date: Sep. 5, 2007

(30) Foreign Application Priority Data
Apr. 10, 2004 (DE) 10 2004 017 631.0

(51) Int. Cl. B60R 21/09; B62D 25/08

(52) U.S. Cl. 280/748

(57) ABSTRACT

In a motor vehicle having a front-end structure, a front bulkhead separates the front-end structure from an interior space, and a braking unit fixed to the front bulkhead has a master brake cylinder and a brake booster. The braking unit is pivotable about a pivot axis which runs through the front bulkhead, with an arrangement for pivoting the braking unit being arranged at a distance from the pivot axis and interacting with components arranged in the front-end structure in the event of a vehicle collision. In order to reliably reduce the risk of injury to a driver of a motor vehicle in the footwell region in the event of a vehicle collision, a transmitting element is provided to prevent a relative movement between the arrangement for pivoting the braking unit and the pivot axis.

### BACKGROUND AND SUMMARY OF THE INVENTION

This invention relates to a safety device for a motor vehicle having a front-end structure, a front bulkhead which separates the front-end structure from an interior space, and a braking unit which is fixed to the front bulkhead and has a brake cylinder.

A safety device for a motor vehicle having a front-end structure and a front bulkhead which separates the front-end structure from an interior space is known from German document DE 198 39 521 C1. A braking unit having a brake cylinder is fastened to the known front bulkhead. Positive guidance elements which interact with a support attachment arranged on the brake cylinder of the braking unit are also provided on the bodyshell structure in the front end. In the event of a vehicle collision in which the front end is deformed, the mechanical positive guidance means are displaced in the direction of the braking unit. If the deformation is great enough, the mechanical positive guidance means engage on the support flange on the braking cylinder and cause a targeted pivoting movement of the braking unit. The braking unit is connected to a brake pedal which projects into the interior space. As a result of the pivoting movement of the braking unit, the brake pedal is pivoted out of the footwell.

It is also known from the prior art to provide components or assemblies, such as for example a motor, arranged in the front-end structure with specific positive guidance means which are assigned to the braking unit. Reference is made in this regard to, for example, Japanese document JP 10-338 167 A1. It is also known from the prior art to provide the braking cylinder of a braking unit with means for pivoting the braking unit, which means interact with components arranged in the front-end structure in the event of a vehicle collision.

A safety device for a motor vehicle having a front-end structure and a front bulkhead which separates the front-end structure from an interior space is known from German document DE 169 31 359 A1. A braking unit which has a master brake cylinder and a brake booster, which are arranged one behind the other in the vehicle longitudinal direction, is fixed to the front bulkhead. The brake booster is fastened to the front bulkhead. A component in the form of a metal sheet, which is provided with reinforced portions at both ends, is fastened to the known braking unit. If the front-end structure is deformed, the component is deformed with it at an early stage. The deformation of the component is transmitted to a second component, which fails in a targeted fashion as a result, causing a further action to be triggered. The further action is the opening of a connecting duct between a main pressure chamber and an auxiliary pressure chamber, as a result of which pressure in the main pressure chamber can be dissipated and a blockage of the brake pedal can be released.

The present invention has as one object the object of producing a safety device for a motor vehicle having a front-end structure, a front bulkhead, and a braking unit which is fixed to the front bulkhead. By way of the safety device, the risk of injury to a driver of a motor vehicle in the foot region in the event of a vehicle collision is reliably reduced.

This object is achieved by means of a safety device for a motor vehicle having the features claimed.

The invention is distinguished by a braking unit which is fixed to the front bulkhead and has a master brake cylinder and a brake booster. Means are provided for pivoting the braking unit about a pivot axis which runs through the front bulkhead. Here, the means for pivoting the braking unit are arranged at a distance from the pivot axis and interact with components arranged in the front-end structure in the event of a vehicle collision. According to the invention, a transmitting element that prevents a relative movement between the means for pivoting the braking unit and the pivot axis is provided. The transmitting element can, for example, be a force transmitting element. Said element can be arranged such that, in the event of a force being exerted on the braking unit by the components arranged in the front-end structure, the braking unit actually pivots about the pivot axis which runs through the front bulkhead. The transmitting element can, for example, be arranged such that it braces together the elements which belong to the braking unit, such as the master brake cylinder and the brake booster, so that the braking unit is pivoted as a whole and there are no relative movements between the individual components of the braking unit. As a result, the braking unit actually pivots about the pivot axis which runs through the front bulkhead, that is to say the front bulkhead is also actually deformed, and the pedals are reliably pivoted out of the footwell, in the event of a vehicle collision. The bracing effect can be provided, for example, in the axial direction of the braking unit. The transmitting element thus serves, in other words, to transmit the forces introduced into the braking unit in such a way that the entire braking unit is pivoted about the desired point.

According to one embodiment, the master brake cylinder and the brake booster are arranged one behind the other in the vehicle longitudinal direction, with the brake booster being fastened to the front bulkhead.

It is conceivable to assign the means for pivoting the braking unit to the forward-facing end side of the master brake cylinder. These means therefore project relatively far into the front-end structure, resulting in the braking unit becoming involved in a deformation of the front-end structure already at an early stage by interacting with the components arranged in the front-end structure. As a result of becoming involved in the front-end deformation at the early stage, the braking unit can rotate through a relatively large pivot angle, so that the brake pedal is reliably pivoted out of the footwell. It is of course also conceivable to fasten the means for pivoting the braking unit to another suitable point of the braking unit.

The means for pivoting the braking unit can be formed as a deflecting tip having a sliding face. In the event of a vehicle collision in which the front-end structure is deformed, the sliding face interacts with components arranged in the front-end structure. With suitable alignment of the sliding plane, the interaction of the latter with the components arranged in the front-end structure causes the desired pivoting movement of the braking unit and of the pedal, which is connected to the braking unit. A deflecting tip having a sliding face constitutes a simple mechanical solution with which positive guidance can be obtained. The desired movement can be set with little expenditure by suitably aligning the sliding face.

The sliding face can be aligned such that the braking unit performs a pivoting movement about a substantially horizontal axis in the event of a vehicle collision. The pivoting movement ensures that the brake pedal is reliably pivoted out of the footwell of the motor vehicle interior space.

It is conceivable to design the transmitting element as a tensile connection which extends from the means for pivoting the braking unit to the pivot axis. A tensile connection constitutes a reliable means for transmitting forces in a defined direction. It is also a simple structural means for coupling an existing structure—the braking unit which comprises two elements which are arranged one behind the other—together in such a way that, in the event of a targeted introduction of force, a compact unit is generated and a relative movement between two points of the braking unit, specifically the point at which force is introduced and a desired pivot axis, is prevented.

The transmitting element can, for example, be embodied as a sheet metal strip. A sheet metal strip constitutes a simple and cost-effective structural solution for a transmitting element which must transmit forces in one direction. In addition, it is possible to effectively vary the properties of the tensile connection, for example its elasticity, through suitable material selection. It is of course also conceivable to produce the transmitting element from other materials.

If the sheet metal strip extends over the entire length of the braking unit, the master brake cylinder and the brake booster are braced together axially in such a way that forces which are introduced into the front tip of the master brake cylinder cause a pivoting movement about a rear fastening point of the brake booster.

The sheet metal strip can be fastened to the deflecting tip by means of detachable fastening elements. Detachable fastening elements can include, for example, screws. This type of fastening can be transferred in a particularly simple fashion to existing designs. All other conventional types of fastening between the sheet metal strip and the braking unit are of course also conceivable, such as non-detachable types of fastening.

The invention is explained in more detail in the following on the basis of the exemplary embodiment illustrated in the drawings.

### BRIEF DESCRIPTION OF THE DRAWINGS

FIG. 1 is a schematic side view of the safety device according to the invention for a motor vehicle having a front-end structure, and

FIG. 2 is a detailed illustration of the safety device according to the invention.

### DETAILED DESCRIPTION OF THE INVENTION

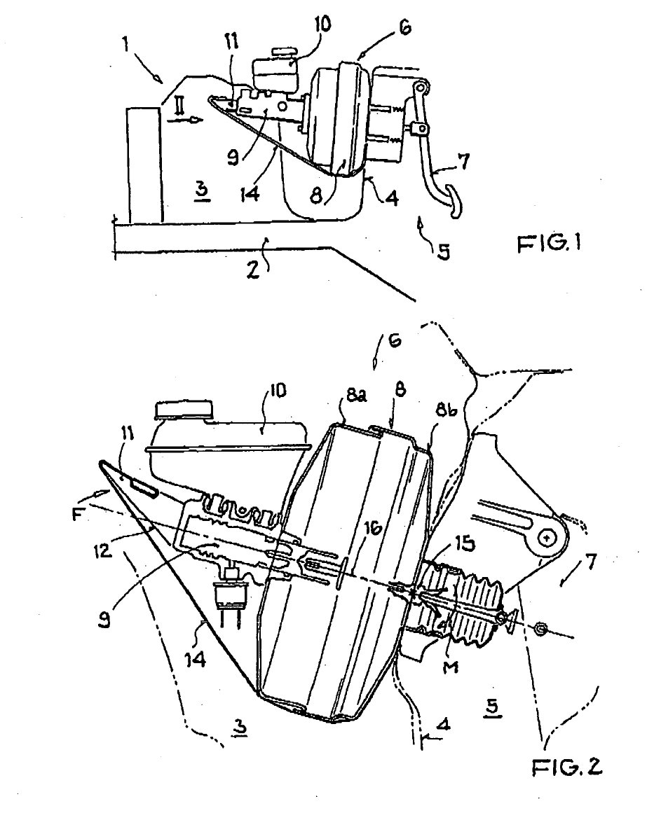

A passenger vehicle has, in a manner which is fundamentally known, a front-end structure 1 (not fully illustrated in FIG. 1) which has as bodyshell parts, inter alia, two front-end longitudinal members 2 and, for each vehicle side, in each case one spring strut bracket 3 or one wheel housing. The front-end longitudinal members 2 merge into a front bulkhead 4 which forms the termination of the front-end structure 1 in the direction of the passenger compartment and the vehicle interior space. In a manner which is fundamentally known, a brake pedal 7 projects into a footwell 5 of the vehicle interior space, and the brake pedal 7 is connected to a braking unit 6. The braking unit 6 is fixed to the front bulkhead 4.

The front-end structure 1 encloses a front-end space which, in front-engined vehicles, constitutes an engine bay and, in rear-engined or mid-engined vehicles, constitutes a luggage space or loading space.

The braking unit 6 is fastened to the front bulkhead 4 in such a way that a brake booster 8 is situated on that side of the front bulkhead 4 which faces towards the front-end space, that is to say the engine bay or the luggage space or loading space. The brake booster 8 is adjoined to the front in the vehicle longitudinal direction by a master brake cylinder 9 which is likewise part of the braking unit 6. A pressure medium storage tank 10 can be arranged above the master brake cylinder 9 in a known way.

A means 11 for pivoting the braking unit 6 is provided in a front end region of the braking unit 6, in a front end region of the brake cylinder 9 in the illustrated exemplary embodiment. This means 11 is explained in more detail in the following with reference to FIG. 2.

FIG. 2 is a detailed illustration of the safety device according to the invention. In it is illustrated the braking unit 6 which has a brake booster 8 and a master brake cylinder 9. These two components are arranged one behind the other in the vehicle longitudinal axis, with the brake booster 8 being fastened to the front bulkhead 4. A pressure medium storage tank 10 is arranged above the master brake cylinder 9. A means 11 for pivoting the braking unit 6 is provided at the forward-facing end of the master brake cylinder 9. The means 11 is embodied as a deflecting tip and has a sliding face 12. The sliding face 12 is assigned to components arranged in the front-end structure, such as for example a spring strut dome, that is to say the inclined sliding face 12 points in the direction of the spring strut dome.

To axially brace the braking unit 6, a sheet metal strip 14 is provided which extends over the entire axial length of the braking unit 6. This sheet metal strip 14 is fastened at the front to the deflecting tip 11, specifically to the top of the latter, that is to say to the opposite side from the sliding face 12. The sheet metal strip 14 is connected to the deflecting tip 11 there by means of, for example, a screwed clamping mechanism (not illustrated). The sheet metal strip 14 is guided along the sliding face 12 and past the master brake cylinder 9. The sheet metal strip 14 does not come into contact with either the sliding face 12 or the master brake cylinder 9. It comes into contact again only with the brake booster 8. The brake booster 8 comprises two shells 8a and 8b whose open sides point towards one another, so that the master brake cylinder 8 has an overall cylindrical shape. The cylinder 8 is aligned such that its axis of symmetry 16 extends as an elongation of an axis of the master brake cylinder. The sheet metal strip 14 is guided past the cylinder at the outside and is substantially in contact there with the lateral surface.

At the rear end of the braking unit 6, the sheet metal strip is guided along and past, and likewise bears against, the circular base face of the brake booster 8. The sheet metal strip is pushed there onto bolts (not illustrated) which serve to mount the braking unit 6 on the front bulkhead 4. During the mounting process, the sheet metal strip 14 of the brake booster 8 is clamped between the latter and the front bulkhead 4.

The mode of operation of the safety device according to the invention for a motor vehicle having a front-end structure is described in the following. In the event of a vehicle collision, the front-end structure 1 is deformed in such a way that the front-end longitudinal member 2 and the spring strut dome or bracket move in the direction of the front bulkhead 4. As a result, components arranged in the front-end structure 1 are likewise moved in the direction of the front bulkhead 4. If the deformation is great enough, a time is reached at which the forward-pointing sliding plane 12 of the deflecting tip 11 of the braking unit 6 impacts against the components arranged in the front-end structure 1, such as the spring strut bracket. As a result of the alignment of the sliding plane 12, the braking unit 6 is rotated about a substantially horizontal pivot axis 15. The braking unit 6 therefore performs a tilting movement. The tilting movement takes place clockwise viewing the illustration of FIG. 1. This tilting movement of the braking unit 6 moves the brake pedal 7, which is coupled to the braking unit 6, out of the footwell in driving direction forwards, so that the risk of injury to the driver in the foot region is reduced.

The sheet metal strip 14 is provided to ensure that the pivoting movement is actually performed about the pivot axis 15, that is to say that the braking unit 6 is pivoted as a whole. The sheet metal strip 14 serves to direct the force F, which is introduced into the sliding face 12, past the braking unit at the outside via the tension band, and to generate a torque M about the pivot axis 15.

1-9. (canceled)

10. A safety device for a motor vehicle comprising:
front-end structure,
a front bulkhead which separates the front-end structure from an interior space,
a braking unit, fixed to the front bulkhead and having a master brake cylinder, a brake booster, and pivoting means for pivoting the braking unit about a pivot axis which runs through the front bulkhead, said pivoting means being arranged at a distance from the pivot axis and interacting with components arranged in the front-end structure upon a vehicle collision, and
a transmitting element which prevents a relative movement between the pivoting means and the pivot axis.

11. The safety device as claimed in claim 10, wherein the master brake cylinder and the brake booster are arranged one behind the other in the vehicle longitudinal direction, and wherein the brake booster is fastened to the front bulkhead.

12. The safety device as claimed in claim 10, wherein the pivoting means for pivoting the braking unit are arranged on a forward-facing end of the master brake cylinder.

13. The safety device as claimed in claim 10, wherein the pivoting means are formed as a deflecting tip having a sliding face.

14. The safety device as claimed in claim 13, wherein the pivot axis is a substantially horizontal axis, and wherein the sliding face is aligned such that the braking unit performs a pivoting movement about the substantially horizontal axis upon a vehicle collision.

15. The safety device as claimed in claim 13, wherein the transmitting element is a tensile connection which extends from the pivoting means to the pivot axis.

16. The safety device as claimed in claim 15, wherein the transmitting element is a sheet metal strip.

17. The safety device as claimed in claim 16, wherein the sheet metal strip extends over the entire length of the braking unit.

18. The safety device as claimed in claim 16, wherein the sheet metal strip is fastened to the deflecting tip by detachable fastening elements.

19. The safety device as claimed in claim 11, wherein the pivoting means for pivoting the braking unit are arranged on a forward-facing end of the master brake cylinder.

20. The safety device as claimed in claim 17, wherein the sheet metal strip is fastened to the deflecting tip by detachable fastening elements.
